(19) United States
(12) Patent Application Publication
(10) Pub. No.: US 2003/0061108 A1
(43) Pub. Date: Mar. 27, 2003

(54) Online purchasing and inventory distribution of materials

(76) Inventors: Junh-Hsien Tu, Taipei (TW); Yi-Ming Liao, Taipei (TW); Shiou-Yu Hung, Taipei (TW); Shih-Chan Chen, Taipei (TW); Cheng-Ju Chen, Taipei (TW); Kuo-Ching Hong, Taipei (TW); Shu-Mei Chien, Taipei (TW); Yun-Chi Lee, Taipei (TW)

Correspondence Address: BIRCH STEWART KOLASCH & BIRCH, PO BOX 747, FALLS CHURCH, VA, 22040-0747, US

(21) Appl. No.: 09/960,524

(22) Filed: Sep. 24, 2001

(51) Int. Cl. G06F 17/60

(52) U.S. Cl. 705/26

(57) ABSTRACT

The invention pertains to a method of online purchasing and inventory distribution of materials. Through the combination of an inventory management system and an accounting system, approved materials are temporarily stored in a supplier's temporary stored area in a storage of the purchaser. Only after the materials are indeed shipped to the production lines will the payment procedure begin. Using such a model of online purchasing to pay at the same time materials are used can transfer part of the material stocking cost over to the suppliers, thus lowering the stocking cost at the purchaser. Applying this method of completing material payment at the same time materials are supplied can not only simplify material shipping procedure but also ensure the timing for materials needed immediately on the production lines.

### BACKGROUND OF THE INVENTION

1. Field of Invention

The invention relates to a business method of implementing trades over a network and, in particular, to a method of online purchasing and inventory distribution of materials that can lower the material stocking cost on the purchaser and simplify the material distribution procedure as well.

2. Related Art

For most enterprises or product manufacturers, there are many ways to increase the profits. Cost management is one of them. Among all types of costs, material cost management receives particular attention by the business. To satisfy clients, end users or customers in the demand for products, an enterprise or manufacturer has to properly prepare sufficient materials to maintain normal capacity. Yet just maintaining few material stocks may lose potential business chances, resulting in unbalanced demands and supplies on the market or a low or vanishing market occupancy. On the other hand, preparing too many stocks also may cause serious financial pressure, difficulty in distributing resources and increases in management costs. Eventually, there is a risk to lose the marginal profit due to the changes in the market.

Existing inventory control techniques, such as the U.S. Pat. No. 6,078,900 entitled “Method for estimating stock levels in production-distribution networks with inventory control” and the U.S. Pat. No. 6,205,431 entitled “System and method for forecasting intermittent demand”, already proposed methods for inventory management. However, these techniques mainly involve computation with several kinds of variables or collection of information to forecast or determine an optimal stocking amount. Therefore, these methods are rather complicated in practice.

FIG. 1 shows an example of the traditional online material purchasing procedure. According to the material purchasing procedure on the material purchaser (such as an enterprise or a product manufacturer), the material demand (such as an order from a product retailer) entered through a terminal 11 and the current stocking quantity in an inventory management system 12 are computed by an MRP (Material Requirements Planning) that is installed on an enterprise server host 13 to generate an order 14 containing materials demand information. Then the order 14 is transmitted via a network or mail to materials suppliers 15 (including several material suppliers). The above materials suppliers will deliver the ordered materials to the materials purchaser according to the order content. The purchaser will do IQC (Incoming Quality Control)—the materials checking procedure 16, and then transfer approved materials to a storage 17 which belong to purchaser and was recorded in the inventory management system 12. In accordance with the purchased material quantities, an accounting system in the enterprise server host 13 makes a payment.

The drawback in this type of online material purchasing procedure is that the purchased materials have to be further distributed before they can be used on the production line. In fact, there is always a period of time from the materials are inspected until they are used in the production line. Nevertheless, in the traditional material purchasing processes, once the purchaser checks and accepts the materials, the purchaser has to make a payment. Then the approved materials would be transferred into a storage, waiting for production orders. Therefore, the purchaser would increase unnecessary costs even said accepted materials have not been used yet. Furthermore, the materials moved to the purchaser storage may become useless trash due to the market changes during the stocking period. On the other hand, such an online material purchasing procedure directly registers purchased materials in the inventory management system without combining with the material distribution processes. This will cause inconvenience in retrieving the materials.

### SUMMARY OF THE INVENTION

An object of the invention is to provide a method of controlling the inventory cost of materials.

Another object of the invention is to provide a method of rapidly retrieving temporarily stored materials so that the production line can quickly obtain needful materials in the supplier's temporary stored area which is located in purchaser's storage and belongs to the purchaser without going through a complicated material application procedure. The invention can achieve the goal of simplifying the material distribution procedure.

The invention mainly combines the stocking material distribution procedure and the accounting system so that the online payment procedure is not executed until the materials are indeed distributed to the production lines. Therefore, the purchaser can save the cost of stocked materials through said online purchasing model. Furthermore, the production line can also immediately obtain needful approved materials when taking a production order. Thus, the invention can ensure all materials ready for manufacturing.

The disclosed method further includes the method of stocked materials distribution. It completes the materials distribution process at the same time when the online payment procedure is performed after the materials are approved.

In the online purchasing procedure proposed herein, the purchaser first sends a forecast order with a forecasting demand to a material supplier. The material suppliers will ship the required materials (according to said forecast order) to the purchaser. Then the purchaser will do IQC (Incoming Quality Control) to inspect materials, and purchaser transfers the checked and accepted materials to the supplier's temporary stored area which is located in purchaser's storage and belongs to the purchaser. At the moment, the purchaser doesn't need to make any immediate payment until the checked and accepted materials stored in supplier's temporary stored area are distributed to the production lines. This material purchasing method combining the material distribution process can realize the above-mentioned object.

### BRIEF DESCRIPTION OF THE DRAWINGS

The present invention will become more fully understood from the detailed description given hereinbelow illustration only, and thus are not limitative of the present invention, and wherein:

FIG. 1 illustrates a traditional online purchasing procedure;

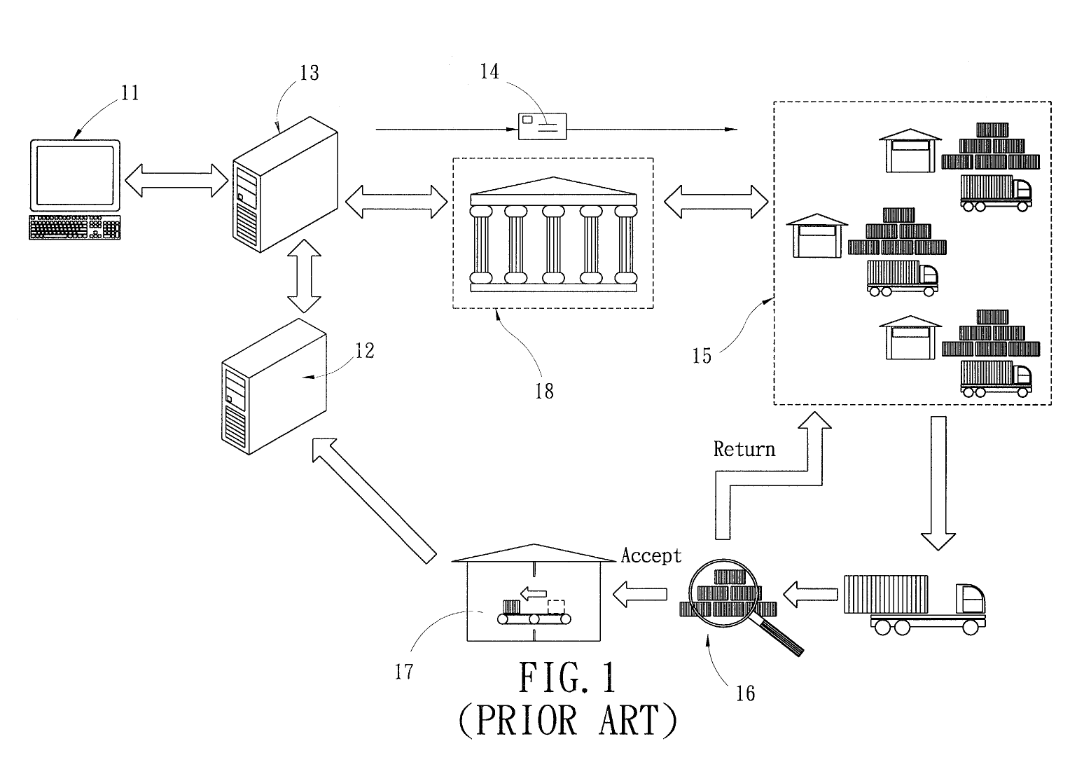

FIG. 2 shows a system structure for implementing the disclosed method;

FIG. 3 is a flowchart showing the main steps in the invention;

FIG. 4 is a local flowchart illustrating the procedure of sending material orders;

FIG. 5 is a local flowchart illustrating the procedure of checking materials; and

FIG. 6 is a local flowchart illustrating the procedure of shipping materials and online payment.

### DETAILED DESCRIPTION OF THE INVENTION

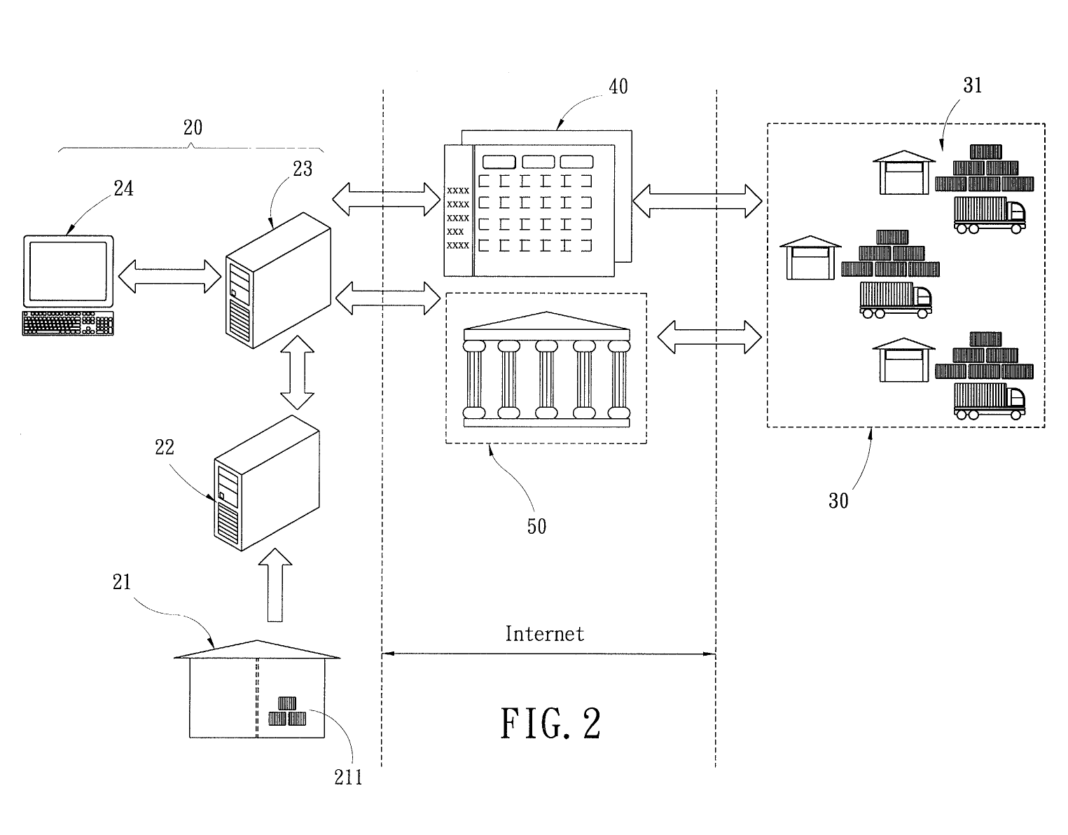

With reference to FIG. 2, the system for performing a material purchasing process includes: a purchaser 20, materials supplier group 30, a network trading center 40, and an EPS (Electronic Payment System) 50.

The purchaser is the party that requires materials, such as an enterprise or a product manufacturer. The purchaser 20 includes a storage 21, an inventory management system 22, and an enterprise server host 23. The storage 21 has a supplier's temporary stored area 211 for temporarily storing the approved materials from a materials supplier 31. The inventory management system 22 is installed in a computer in the storage 21 to record the inventory information about stocks in the storage 21, such as items and quantities. The enterprise server host 23 contains at least an accounting management system, a material purchasing system, an MRP (Material Requirements Planning) utility, and a material distribution system to perform online material purchases, material distributions and online payments.

The materials supplier group 30 is consisted of many materials suppliers 31. They communicate with the purchaser via the Internet and provide the materials requested by the purchaser 20. The network trading center 40 communicate with the purchaser 20 and the materials supplier group 30 via the Internet, functioning as an intermediate processing website. It records trading information during the network trading process and provides services for network trading, such as exchanges of advertisements and information. The EPS 50 provides the online payment service between the purchaser 20 and the materials supplier 31 through the Internet.

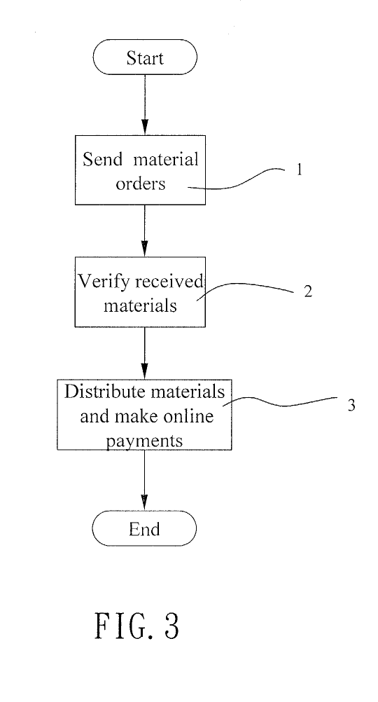

The disclosed method (FIG. 3) includes the following steps:

1. Send material orders;

2. Verify received materials; and

3. Distribute materials and make online payments.

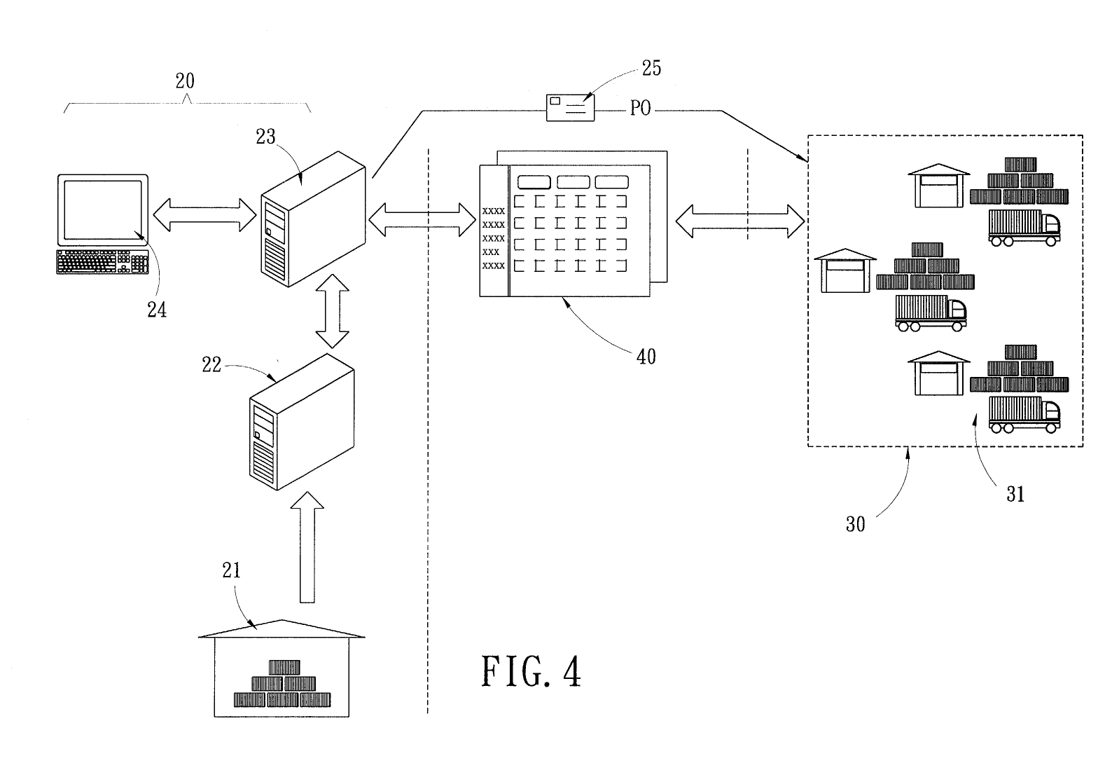

The procedure of step 1 of sending a material order as shown in FIG. 4 includes:

1-1 Generate a material order 25: The material order contains forecast material demand information computed in accordance with future material demand (e.g. a salesperson enters an order from a product retailer at a terminal 24 connecting to the enterprise server host 23) and the current stocks stored in the inventory management system 22. The forecast material demand information contains required items, quantities, and demand time schedule. The purchaser 20 normally uses the MRP to compute the forecast information and then generates a material order 25 containing the forecast information.

1-2 Send the material order 25 to a materials supplier 31. A material purchasing system of the enterprise server host 23 sends out the material order 25 to the materials supplier 31 to order the materials needed. There are two ways to send such an order 25:

a. The forecast order is sent to some materials supplier 31 through the Internet;

b. The forecast order is sent to several materials supplier group 30 through the Internet. For example, the material order 25 can be posted to a network trading center 40, through which the order 25 is sent to the materials supplier group 30.

Another preferred embodiment also includes the step of sending the material order 25 by PO (Postal Order) so as to notify the materials suppliers 31.

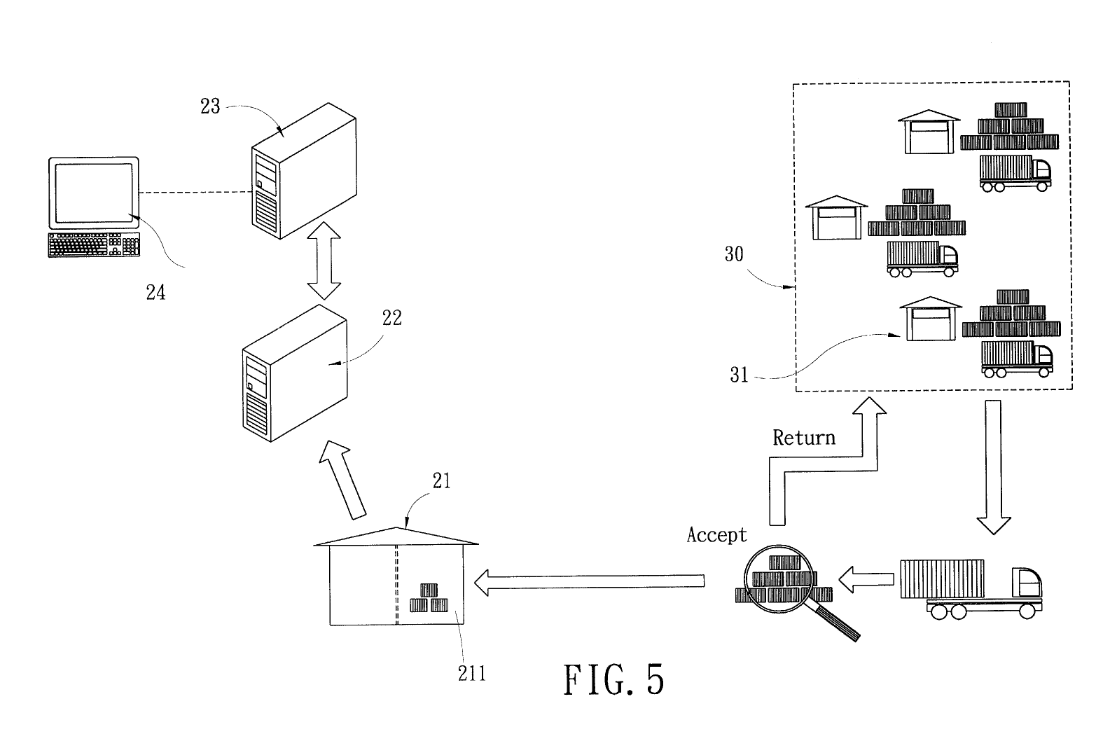

In the step of check materials in step 2, the procedure is shown in FIG. 5. When the materials supplier 31 ships the materials ordered in the material order 25 to the purchaser 20, the material control and management personnel in the purchaser 20 can obtain the record of the material order 25 via the Intranet of the purchaser 20 to check the delivered items, quality, and quantities according to the content of the material order 25. Those that are not qualified are returned back to the original materials supplier 31. The qualified ones are then transferred to a supplier's temporary stored area 211 in a storage 21 of the purchaser 20. The supplier's temporary stored area 211 is a special area assigned for storing materials. Although materials stored in the supplier's temporary stored area 211 are approved materials of good quality, the payment is yet made to the materials supplier and the materials still belong to the materials supplier 31. The purchaser 20 does not have to pay the cost for stocking materials.

In the step of checking materials, there is further a step of updating inventory information. In addition to including information of the delivered materials approved by the management personnel in the inventory information in the inventory management system 2, the material purchasing system of the enterprise server host 23 further compares the updated inventory information in the inventory management system 22 with the material order 25. This is to check whether the materials delivered by the supplier are the same as the materials ordered. If there is any deficiency, the supplier will be asked to reship again. Another object of the step is to make sure the ordered materials are all shipped to the supplier's temporary stored area 211 in the storage 21.

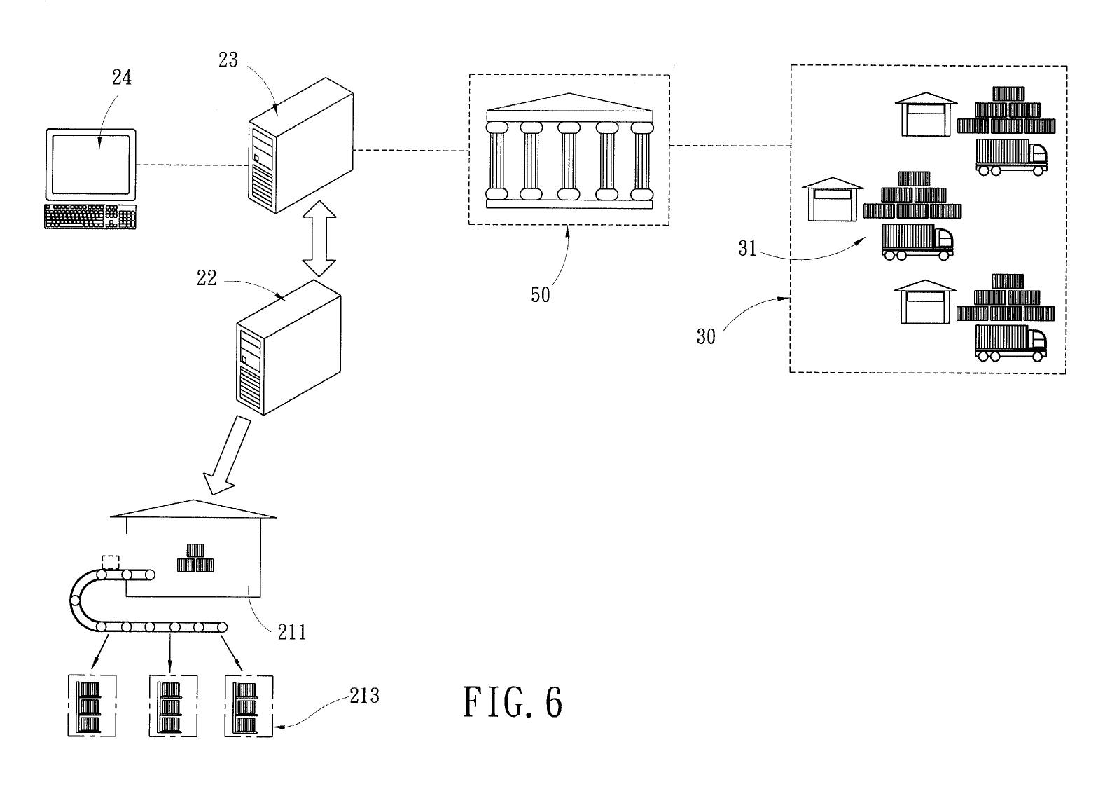

The step of material distribution and online payment in step 3 mainly simplifies the traditional step of material application inside the enterprise. The traditional procedure of filing material application through various steps by material demanders (i.e. the production lines) are simplified and combined into the above-mentioned online material purchasing process. The detail is shown in FIG. 6:

3-1. Materials are retrieved from the supplier's temporary stored area 211. The material distribution system computes the real-time demand information according to the materials immediately needed by the production lines, in particular the real-time demand information obtained by statistically calculating the material demand in the forecast information. Afterwards, the material distribution system move the materials stored in the supplier's temporary stored area 211 in the storage 21 to the production lines 213, with a material distribution completion message sending out at the same time. The material demander therefore does not need to go through steps to file an application for materials in order to obtain the desired materials.

3-2. Complete payment online. When the enterprise server host 23 receives the material distribution completion message from the material distribution system, the purchaser immediately sends the payment to the materials supplier 31 through an EPS 50.

The material retrieval process of step 3-1 further includes a material selection step to determine the order of material distribution. The materials stored in the supplier's temporary stocking area 211 may include materials from several materials suppliers 31. In particular, when a specific material is shipped from several materials suppliers 31, there is a difference in the shipping times. In accordance with the first-in-first-out principle, the material distribution system automatically selects the material shipped at the earliest time according to the shipping time recorded in the inventory information and sends them to the production lines 213.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of online purchasing and inventory distribution of materials to complete material purchasing processes between a purchaser and a materials supplier through the Internet and to distribute materials inside the purchaser, the method being comprised of:
the step of sending an order, in which an enterprise server host in the purchaser computes material demand forecast information according to the current inventory quantity and input material demand quantity stored in an inventory management system and sends a material order containing the material demand forecast information to a materials supplier;
the step of checking delivered materials, in which the content of the material order is used to verify with the items, quality and quantities of materials delivered by the materials supplier and the accepted ones are shipped to a supplier's temporary stored area in a storage and otherwise returned back to the materials supplier; and
the step of material distribution and online payment, in which the needed materials are moved from the supplier's temporary stored area to production lines and the enterprise server host makes a payment for the materials moved to the production lines to the materials supplier through an EPS (Electronic Payment System).

2. The method of claim 1, herein the materials order is sent to a materials supplier through the Internet.

3. The method of claim 1, wherein the material order is posted onto a network trading center on the Internet to notify relevant materials suppliers.

4. The method of claim 1 further comprising the step of sending the material order in PO (Postal Order).

5. The method of claim 1, wherein the step of checking materials further comprises the step of updating inventory information to add checked and accepted material information into the inventory information in the inventory management system.

6. The method of claim 1, wherein the step of material distribution and online payment includes:
the step of retrieving materials from the supplier's temporary stored area, in which a material distribution system in the enterprise server host computes the real-time demand information according to the materials immediately needed by the production lines, moves the materials stored in the supplier's temporary stored area to the production lines and then sends out a material distribution completion message; and
the step of online payment, in which the enterprise server host makes a payment to the materials supplier through the EPS after receiving the material distribution completion message.

7. The method of claim 6 further comprising the step of selecting materials, in which a specific material in the supplier's temporary stored area with the earliest shipping time according to the shipping time record in the inventory information is selected and distributed to the production lines.
